(19) United States
(12) Patent Application Publication
(10) Pub. No.: US 2020/0268003 A1
(43) Pub. Date: Aug. 27, 2020

(54) SYSTEM AND METHOD FOR IMPROVING SURFACE REDNESS OF DARK-CUTTING LOGISSIMUS STEAKS

(71) Applicant: The Board of Regents for Oklahoma State University, Stillwater, OK (US)

(72) Inventors: Ranjith Ramanathan, Stillwater, OK (US); Gretchen G. Mafi, Coyle, OK (US); Deborah L. VanOverbeke, Glencoe, OK (US)

(73) Assignee: THE BOARD OF REGENTS FOR OKLAHOMA STATE UNIVERSITY, Stillwater, OK (US)

(21) Appl. No.: 16/794,462

(22) Filed: Feb. 19, 2020

Related U.S. Application Data
(60) Provisional application No. 62/808,480, filed on Feb. 21, 2019.

(51) Int. Cl. A23B 4/20; A23B 4/12; A23B 4/24; A23L 13/40

(52) U.S. Cl. CPC A23B 4/20; A23B 4/12; A23V 2002/00; A23L 13/428; A23B 4/24

(57) ABSTRACT

According one embodiment, a post-harvest processing technology has been developed that enhances the red color of dark cutting beef to a near-normal or normal red color through the use, in one embodiment, of a Rosemary solution in a concentration of between 0.1% and 0.2% Rosemary which is applied to the beef, after which it is stored in a nitrite-embedded film packaging for a predetermined period of time. Various embodiments indicate that that nitrite-embedded packaging and, more particularly, nitrite-embedded packaging in combination with the use of pre-storage antioxidant wash, has the potential to improve surface color of dark-cutting beef.

### CROSS REFERENCE TO RELATED APPLICATIONS

This application claims the benefit of U.S. Provisional Patent Application Ser. No. 62/808,480 filed on Feb. 21, 2019, and incorporates said provisional application by reference into this document as if fully set out at this point.

### TECHNICAL FIELD

This disclosure relates generally to systems and methods of preparing meat for consumption and, more particularly, to systems and methods for improving the surface redness of dark-cutting meat.

### BACKGROUND

Maximizing the value of fresh beef is important to recovering lost revenue due to quality defects. Dark-cutting beef is an example of a color deviation in which beef fails to have a characteristic bright-red color. Although this condition has world-wide occurrence (Boykin et al., 2017; Mahmood et al., 2017a; Zhang et al., 2018); the mechanism is not clear. Various studies have concluded that depletion of glycogen prior to slaughter due to chronic stress (Hendrick et al., 1959), less efficient mitochondria (McKeith et al., 2016), and compromised glycolytic enzyme activity (Mahmood et al., 2017b) can be attributed to limited decline of post-rigor muscle pH. A greater muscle pH can enhance mitochondrial oxygen consumption and increase muscle swelling (Ashmore et al., 1972; Hunt and Hedrick, 1977); both processes can decrease bloom.

Myoglobin and fresh meat color: Meat color and tenderness are two important quality parameters that influence purchasing decisions. Nearly 15% of retail beef is discounted in price due to surface discoloration2. Thus, failure to optimize muscle color life results in one billion dollars of lost revenue every year. Meat color is an important quality attribute that influences purchasing decisions as consumers' often associate bright red color with freshness and wholesomeness. Meat color is primarily due to myoglobin, a sarcoplasmic protein present in muscle. In fresh meat, myoglobin can exist in any of three redox states: deoxymyoglobin, oxymyoglobin, and metmyoglobin3. The combination of the valence state and the ligand attached to the central heme determines meat color. Deoxy- and oxymyoglobin forms are in a reduced ferrous state. The color of deoxymyoglobin is purplish-red, commonly seen in the interior of a freshly cut steak or in vacuum packaged meat; whereas oxymyoglobin is responsible for the consumer-preferred bright cherry-red color. Formation of brown colored metmyoglobin on the surface of beef products results from the oxidation of ferrous oxy- and/or deoxymyoglobin. However, meat has an inherent capacity to delay the onset of discoloration by a process called metmyoglobin reduction.

What is a dark cutting beef?: Dark cutting beef is characterized by a high postmortem pH, increased water binding capacity, sticky texture, and the inability to bloom when exposed to air.

Bloom is the development of bright red color when meat is exposed to air, due to the oxygenation of myoglobin to form oxymyoglobin. Since dark cutting meat will not bloom when exposed to air, it is discounted at the retail level 5. Dark cutting beef as a dark, sometimes a blackish, color when cut and fails to develop a cherry-red color expected by the meat trade.

Economic impact: According to the 2011 National Beef Quality Audit 3.2% of the carcasses assessed were dark cutters6. Most meat packers discount dark cutters substantially. During the first National Beef Quality Audit, 5.0 percent of all carcasses surveyed were dark cutters and of that 5.0 percent, 3.4 percent were discounted one-third of a quality grade, 1.1 percent were discounted two thirds of a quality grade and 0.5 percent were discounted one full quality grade. According to the 2000 National Beef Quality Audit, discounts as high as $240 per carcass are associated with dark cutting beef. In 2000, 2.3% of all steer and heifer carcasses were dark cutters, resulting in a loss of $165-$170 million dollars on dark cutting carcasses alone.

In Canada, the proportion of beef carcasses that grades Canada B4 (representing dark cutter) have increased noticeably from an average of 0.8% of total carcasses processed in 1998/99 to 1.3% in 2010/11. The increase in dark cutting carcasses in Canada represents about $11 million in lost carcass value each year and is of significant concern to the Canadian beef industry. The ability to predict the likelihood of an animal producing dark meat is important in the Canadian beef industry because of the economic penalty assessed to dark cutting carcasses.

Causes for dark cutting beef: Several factors such as pre-harvest stress, type of feed, seasonality, housing, and physical activity can influence the rate of dark cutters All these factors can deplete muscle glycogen stores; hence less lactic acid is formed in postmortem muscle. Thus, dark cutters will have high muscle pH which can significantly affect meat quality.

Effects of Increased pH on Meat quality: In normal meat, following slaughter, muscle pH falls from 7.2 to 5.6. However in dark-cutters, pH change is minimal and the final pH ranges from 6.2 to 6.8. Increased pH can affect both physical and biochemical properties of meat.

Effects on muscle structure: When the ultimate meat pH is high, the proteins will have a net charge above their isoelectric point. Proteins will associate with more water in the muscle and therefore fibers will be tightly packed. Therefore, the meat is then dark in color because its surface does not scatter light to the same extent as the more open surface of meat with a lower ultimate pH10. This results in increased light-absorption and less reflectance from the surface, finally results in an undesirable, dark, firm, and dry cut lean surface.

Effects on mitochondrial function: Mitochondria are important organelles primarily responsible for ATP production. In postmortem muscle mitochondria remain functional for more than 45 days. Mitochondrial activity can have a significant effect the appearance of meat. For example, an increased mitochondrial activity in meat will result in lesser oxygen for myoglobin. In normal meat, postmortem glycolysis reduces pH to 5.8 or lower which impairs mitochondrial oxygen consumption8 and allows normal bloom on meat surfaces exposed to air. Mitochondrial cytochrome oxidase was more active at pH values above 6.0, and concluded that increased oxygen consumption of dark cutting meat could increase the concentration of deoxygenated myoglobin, thus resulting in the dark color. It has been proposed that the dark color of the meat results from enhanced oxygen consumption, impaired oxygen permeability of the carcass, or a combination of both.

Effects on microbial growth: A greater pH allows spoilage bacteria to grow readily thus limiting its shelf life. However, packaging conditions, antimicrobial application, and maintaining cold chain can limit bacterial growth.

Post-harvest techniques utilizing enhancement and modified atmospheric packaging have been used to improve the appearance of dark-cutting beef (Wills et al., 2017). Lactic acid-enhancement promotes localized muscle discoloration (Apple et al., 2011), while modified atmospheric packaging with high-oxygen or carbon monoxide can increase lipid oxidation and consumer concerns at the retail level, respectively (Cornforth and Hunt, 2008; English et al., 2016a).

Thus, what is needed is a method of improving the appearance of dark-cutting beef which does not suffer the disadvantages of prior art approaches.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

Nitrite-embedded packaging such as FreshCase® packaging films offer an alternative strategy to improve surface color under anaerobic conditions. More specifically, nitric oxide formed from nitrite can bind with deoxymyoglobin to form bright-red nitric oxide myoglobin (Fox and Ackerman, 1968). This technique has been used to improve redness of aged beef longissimus lumborum, psoas major, and semitendinosus muscles (Claus and Du, 2013) and bison steaks (Roberts et al., 2017). A greater pH promotes mitochondrial oxygen consumption, hence dark-cutting beef will have more deoxymyoglobin on the surface than normal-pH beef (English et al., 2016b). Therefore, nitric oxide can bind with deoxymyoglobin and has the potential to improve redness of dark-cutting beef.

Beef purchasing decisions are influenced by color more than any other quality factor because consumers use discoloration as an indicator of freshness and wholesomeness. Consumers' associate bright red color of steak with freshness and wholesomeness. Any deviation from the bright red color during beef processing leads to discounted price. Dark cutting beef is a condition in which beef will not have the characteristic bright red color. Although mechanism of dark cutting beef is not clear, it is widely accepted that pre-harvest stress leads to depletion of glycogen reserves prior to slaughter, and is often described as meat that fails to brighten after the cut surface has been exposed to oxygen. One aspect of the instant invention is to a post-harvest processing technology that can convert dark cutting beef to normal appearance beef through the use of nitrite-embedded packaging film, preferably in combination with a rosemary wash.

An objective of the instant invention was to determine the effects of nitrite-embedded packaging such as FreshCase® packaging on the lean color of dark-cutting beef. Eight dark-cutting (pH>6.0) and eight USDA Low Choice (normal-pH; mean pH=5.6) beef strip loins (longissimus lumborum) were selected three days after harvest. Each dark-cutting loin was sliced into five 2.5-cm thick steaks and randomly assigned to 1) dark-cutting steak packaged in PVC overwrap, 2) dark-cutting steak packaged in nitrite-embedded film, 2) dark-cutting steaks dipped in 0.2% rosemary solution and packaged in nitrite-embedded film, and 4) dark-cutting steak dipped in deionized water and packaged in nitrite-embedded film The fifth dark-cutting steak was used to determine pH and proximate composition. Normal-pH choice loins were used as a control, and each loin was randomly assigned to either PVC overwrap for retail display or to determine pH and proximate composition. Packages were placed in coffin-style retail display cases under continuous fluorescent lighting for 3 days. A HunterLab MiniScan XE Plus spectrophotometer was utilized to characterize steak color every 24 h.

In this embodiment there was a significant treatment×storage time interaction (P<0.05) for a* values and nitric oxide myoglobin formation. On days 1, 2, and 3 of the display, nitrite-embedded treatment improved (P<0.05) redness compared to other dark-cutting steaks in PVC. A 45% increase in redness (P<0.05) was observed for nitrite-embedded rosemary treatment over dark-cutting steak in PVC on day 3 of display. Nitric oxide myoglobin formation on day 0 was less for all dark-cutting steaks in nitrite-embedded packaging. Metmyoglobin content was greater (P<0.05) on day 0 for dark-cutting steaks packaged in nitrite-embedded treatments than dark-cutting steaks in PVC. However, metmyoglobin level in dark-cutting steaks packaged in nitrite-embedded treatments decreased (P<0.05) on day 1 compared with day 0. Dark-cutting steaks packaged in PVC had greater (P<0.05) L* values on day 0 than other dark-cutting steaks in nitrite-embedded packaging. Conversely, on days 1, 2, and 3, there were no differences (P>0.05) in L* values between dark-cutting treatments. Dark-cutting steaks in nitrite-embedded packaging had lower total plate count (P<0.05) than dark-cutting steak packaged in PVC. The current research indicated that nitrite-embedded packaging has the potential to improve surface color of dark-cutting beef.

By way of summary, no known prior art has assessed the synergistic effect of antioxidants such as rosemary and nitrite packaging on the color of dark-cutters.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 contains an illustration of the effects of nitrite-embedded packaging and retail display on a* values. Treatments included normal-pH steak packaged in PVC, dark-cutting steak packaged in PVC, dark-cutting packaged in nitrite-embedded, dark-cutting steak dipped in 0.2% rosemary solution and packaged in nitrite-embedded film, and dark-cutting steak dipped in distilled water and packaged in nitrite-embedded film. Least square means with different letters (a-g) differ (P<0.05). Standard error for treatment×days of retail display interaction=0.98.

FIG. 2 illustrates the effects of nitrite-embedded packaging and retail display on chroma. Treatments included normal-pH steak packaged in PVC, dark-cutting steak packaged in PVC, dark-cutting packaged in nitrite-embedded, dark-cutting steak dipped in 0.2% rosemary solution and packaged in nitrite-embedded film, and dark-cutting steak dipped in distilled water and packaged in nitrite-embedded film. Least square means with different letters (a-g) differ (P<0.05). Standard error for treatment×days of retail display interaction=1.4.

FIG. 3 contains an illustration of the effects of nitrite-embedded packaging and retail display on nitric oxide myoglobin formation. Treatments included normal-pH steak packaged in PVC, dark-cutting steak packaged in PVC, dark-cutting packaged in nitrite-embedded, dark-cutting steak dipped in 0.2% rosemary solution and packaged in nitrite-embedded film, and dark-cutting steak dipped in distilled water and packaged in nitrite-embedded film. Nitric oxide formation was calculated as the ratio of R650÷R570 nm. A greater number indicates more nitric oxide formation. Least square means with different letters (a-h) differ (P<0.05). Standard error for treatment×days of retail display interaction=0.35.

FIG. 4 contains an illustration of the changes in absorbance spectra of dark-cutting steaks packaged in nitrite-embedded packaging during 3 day retail display.

FIG. 5 contains a pictorial representation of dark-cutting steaks packaged¹ in nitrite-embedded film on day 2 of retail display. Treatments included dark-cutting steaks in traditional PVC packaging (A), dark-cutting steak in nitrite-embedded packaging (C), dark-cutting steak dipped in 0.2% rosemary solution and packaged in nitrite-embedded film (R), dark-cutting steak dipped in distilled water and packaged in nitrite-embedded film (W). Approximately 50% increase in redness was noticed with new packaging.

FIG. 6 illustrates the effects of nitrite-embedded packaging' and retail display on L* values. Treatments included normal-pH steak packaged in PVC, dark-cutting steak packaged in PVC, dark-cutting packaged in nitrite-embedded, dark-cutting steak dipped in 0.2% rosemary solution and packaged in nitrite-embedded film, and dark-cutting steak dipped in distilled water and packaged in nitrite-embedded film Least square means with different letters (a-g) differ (P<0.05). Standard error for treatment×days of retail display interaction=1.2.

FIG. 7 contains a schematic representation of the results of a treatment involving dark-cutting beef packaged in nitrite-embedded packaging where Rosemary was applied as an antioxidant.

FIG. 8 contains a schematic representation of the results of a treatment involving dark-cutting beef packaged in nitrite-embedded packaging where Trolox (water soluble vitamin E) was applied as an antioxidant.

FIG. 9 contains a schematic representation of the results of a treatment involving dark-cutting beef packaged in nitrite-embedded packaging where ascorbic acid (vitamin C) was applied as an antioxidant.

### DETAILED DESCRIPTION

### Raw Materials and Processing

Eight dark-cutting beef carcasses (pH>6.0) and eight USDA Low Choice (normal-pH; mean pH=5.6) beef strip loins (longissimus lumborum; IMPS #180) were selected (visually displayed Small degree of marbling), individually identified, and marked prior to fabrication from the Tyson Fresh Beef Plant at Amarillo, Tex., 3 day after harvest. All carcasses displayed A skeletal maturity, and the normal-pH carcasses displayed A lean maturity. Carcasses were fabricated, strip loins were collected, vacuum packaged, and transported on ice to remain chilled to the Robert M. Kerr Food & Agricultural Products Center at the Oklahoma State University campus in Stillwater. Both dark-cutting and normal-pH were loins cut in half, packaged in 11×22 cm, 3-mil high barrier Cryovac vacuum bags utilizing a Multivac C500 vacuum packager and stored at 2° C. in the dark until use.

Each dark-cutting loin was sliced into five 2.5-cm thick steaks from the anterior end using a meat slicer (Bizerba USA Inc., Piscataway, N.J.) and randomly assigned to four treatments: 1) dark-cutting steak packaged in PVC overwrap, 2) dark-cutting steak packaged in nitrite-embedded film, 2) dark-cutting steaks dipped in rosemary solution and packaged in nitrite-embedded film, and 4) dark-cutting steak dipped in water and packaged in nitrite-embedded film. The fifth dark-cutting steak was used to determine pH and proximate composition. Loins graded USDA Choice were utilized to characterize the color of normal-pH steak. Each normal-pH Choice loin was cut into two steaks from the anterior end and randomly assigned to either package in PVC overwrap for retail display or to determine pH and proximate composition.

### pH and Proximate Composition Analysis

Normal-pH and dark-cutting steak pH was measured on day 0 of display by inserting a pH probe at four different locations within a section using a Mettler Toledo SevenGo pH meter (Mettler Toledo, Columbus, Ohio). Following pH measurement, steaks were ground and two hundred gram samples from normal-pH steaks and dark-cutting beef were utilized to measure moisture, protein, and fat using an Association of Official Analytical Chemist approved FOSS Food Scan™ 78800 near-infrared spectrophotometer (Dedicated Analytical Solutions, DK-3400 Hillerod, Denmark). The proximate composition was recorded on a percentage basis.

### Rosemary Dip Treatment, Packaging, and Simulated Retail Display

Previous research has indicated that a combination of rosemary enhancement and modified atmospheric packaging improved surface redness of dark-cutting beef by 44.5% (Wills et al., 2017). Improved redness in rosemary-enhancement was due to increased reflectance by water, modified gas composition within package, and antioxidant effect. Hence, a rosemary surface dip treatment was also included as an embodiment. The methodology described by Mitsumoto et al. (1991) was utilized for rosemary dip treatment. Briefly, 2.5 cm thick longissimus steak was dipped in 0.2% rosemary solution for 20 sec. The 0.2% rosemary enhancement solution consisted of rosemary oleoresin (Herbalox® oleoresin rosemary, Kalsec; QS-NS: 41-19-49) and deionized water stored at 2° C. Rosemary oleoresin was mixed in deionized water using a hand-held mixer for two min. A deionized water control treatment (without rosemary) also was included. Following dipping, steaks were kept on an inclined rack for 2 min to drain excess rosemary. Following equilibration, steaks assigned to nitrite-embedded film (FreshCase ; Curlon® Grade A5106 Protective Packaging Film; approximately 115 mg/m² nitrite, 6×12 pouches; 7 mil thickness; <0.15 oxygen transmission rate cc/100 in²/24 Hrs@73° F., 0% RH, 1 atm; <0.5 water vapor transmission rate g/100 in²/24 Hrs@100° F., 90% RH, 1 atm; Bemis Innovation Center in Neenah, Wis.) were packaged using a Multivac C500 vacuum packager. Steaks assigned to PVC were placed onto foam trays with absorbent pads (Sealed Air-tray number 3; 22.2 cm×17.1 cm×3.2 cm; Elmwood Park, N.J.) and overwrapped with polyvinyl chloride film (PVC; 15,500-16,275 cm³ O₂/m²/24 h at 23° C., E-Z Wrap Crystal Clear Polyvinyl Chloride Wrapping Film, Koch Supplies, Kansas City, Mo.) using a Winholt film wrap machine (Winholt WHSS-1, 115V; Woodbury, N.Y.).

The amount of rosemary or distilled water uptake in each steak was measured individually by weighing prior to dipping and after draining for 2 min. Intake of rosemary or water was negligible (less than 0.001%). Dipping application resulted in a surface coating of either rosemary solution or distilled water. Packages were placed in coffin-style retail display cases under continuous fluorescent lighting (Philips Fluorescent lamps; 12 Watts, 48 inches; Philips, China; color temperature=3,500° K) and maintained at 2±1° C. for 3 days. The light intensity within the display case ranged from 1000 to 1150 lx (Extech Instruments Corporation, Waltham, Mass.). The packages were rotated daily to minimize the variation due to a location within the display case.

### Instrumental Color

A HunterLab MiniScan XE Plus spectrophotometer (2.5-cm aperture, illuminant A, and 10° standard observer angle; HunterLab Associates, Reston, Va.) was used to measure surface color at two locations. Instrumental color readings were taken on days 0, 1, 2, and 3 of retail display. The objective measure of CIE L*, a*, and b* values and spectral readings from 400 to 700 nm were utilized to characterize the surface color. L* represents lightness on a scale of 0 to 100 and a* indicates redness. The CIE a* and b* values were also used to calculate chroma [√(a*²+b*²)] (AMSA, 2012), which represents strength and weakness of chromatic color (red intensity).

The ratio of reflectance values at 650 nm and 570 nm were calculated as an indicator for nitric oxide myoglobin formation (AMSA, 2012). A greater number indicates more nitric oxide myoglobin formation. In addition, absorbance spectra from 400 to 700 nm were also used to characterize nitric oxide- and metmyoglobin formation. Absorbance was calculated using reflectance values from 400 to 700 nm according to Faustman and Phillips (2001): A=(2−log R), where A represents absorbance and R represents percent reflectance. The ratio of K/S 572÷K/S 525 was used to estimate metmyoglobin (AMSA, 2012). Reflectance values were converted to K/S ratios using the following equation: K/S=(1−R)²÷2R, where R represents the % reflectance expressed as a decimal. K/S ratios were used to make the data more linear and to account for absorptive (absorbance coefficient, K) and scattering (scattering coefficient, S) properties. A lower ratio represents greater metmyoglobin formation.

### Microbiology

Total plate count was determined on dark-cutting steak in PVC and nitrite-embedded treatment on day 3 of display. A sterile 5×5 cm² grid was utilized to swab the surface of each steak with a 3MTM Swab-Sampler with 10 mL buffered peptone water broth (3M™ Maplewood, Minn.). Swab containers were vortexed for 30 s utilizing a Fisher Scientific Vortex-Genie 2™ (12-812; Hampton, N.H.). One mL of the swabbed sample was serially diluted in 9 mL of 0.1% sterile peptone water and one mL of each dilution was aseptically plated on 3M™ Petrifilm™ rapid aerobic count plates (Hampton, N.H.). Plates were incubated in a VWR Forced Air General Incubator (5.4 ft³; VWR, Radnor, Pa.) at 37° C. for 48 h. Following incubation, plates were counted on an Interscience Scan® 100 pressure sensitive pad (Interscience, Woburn, Ma.) to determine total plate count per cm².

### Statistical Analysis

The experimental design was a randomized complete block with repeated measure. Loins served as a block (n=8) and steaks within each loin received 1 of 4 treatments (dark-cutting steak in PVC, dark-cutting steak in nitrite-embedded film, dark-cutting steak dipped in rosemary solution and packaged in nitrite embedded film, dark-cutting steak dipped in water and packaged in nitrite embedded film). Time of color measurement (0, 1, 2, and 3 days) was a repeated measurement. Fixed effects for total plate count had 1-way treatment structure and instrumental color had a 2-way treatment structure of packaging, display time, and their interactions. For the instrumental color, the fixed effects included packaging, display time, and their interactions; however, packaging was the fixed effect for total plate count. For both instrumental color and total plate count, the random term included loin (block) and unspecified residual error. For the instrumental color data, the repeated option in PROC MIXED was used to assess covariance-variance structure among the repeated measures. The most appropriate structure was determined using the Akaike's information criterion output. Type-3 tests of fixed effects for packaging, display time, and their interactions were performed using the Mixed Procedure of SAS (SAS 9.3). Least squares mean for the highest order interactions determined to be significant will be presented. Least squares means were separated using the PDIFF option and were considered significant at P<0.05.

### Results and Discussion

### pH and Proximate Composition

Dark-cutting steaks had greater (P<0.05) pH and moisture content than normal-pH beef (Table 1).

TABLE 1
pH and proximate composition (%) of
normal-pH and dark-cutting steaks

| Trait | Normal-pH | Dark-cutting beef | Standard error |
|---|---|---|---|
| pH | 5.6^{a} | 6.4^{b} | 0.03 |
| Moisture | 67.5^{a} | 71.4^{b} | 0.61 |
| Protein | 22.4^{a} | 21.5^{a} | 0.20 |
| Fat | 7.77^{a} | 7.25^{a} | 0.50 |

Least square means within a row with different letters (a-b) differ (P < 0.05).

However, there were no differences (P>0.05) in protein and fat content between dark-cutting and normal-pH steaks. Pre-harvest stress can decrease glycogen content in muscles, hence limited lactic acid is formed postmortem. Previous studies have also reported greater pH in dark-cutting beef (Sawyer et al., 2009; Mitacek et al., 2018). A greater pH can increase cell swelling or fiber width (Barbut et al., 2005; Hughes et al., 2017), which can decrease light reflectance and oxygen diffusion into the meat. Nitrite embedded/FreshCase® technology uses a vacuum or low oxygen packaging to improve the appearance of fresh beef (Siegel, 2011). Although this packaging technic has been used to improve the appearance of low-color stable muscles such as psoas major or aged beef (Claus and Du, 2013), no research has determined its application in dark-cutting beef.

### Surface Redness

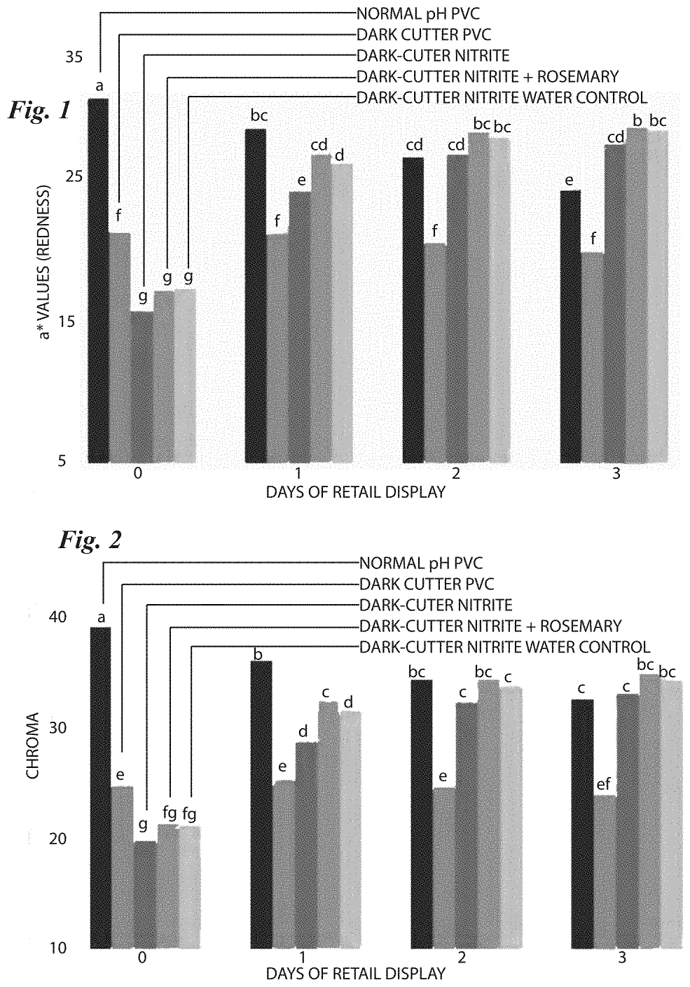

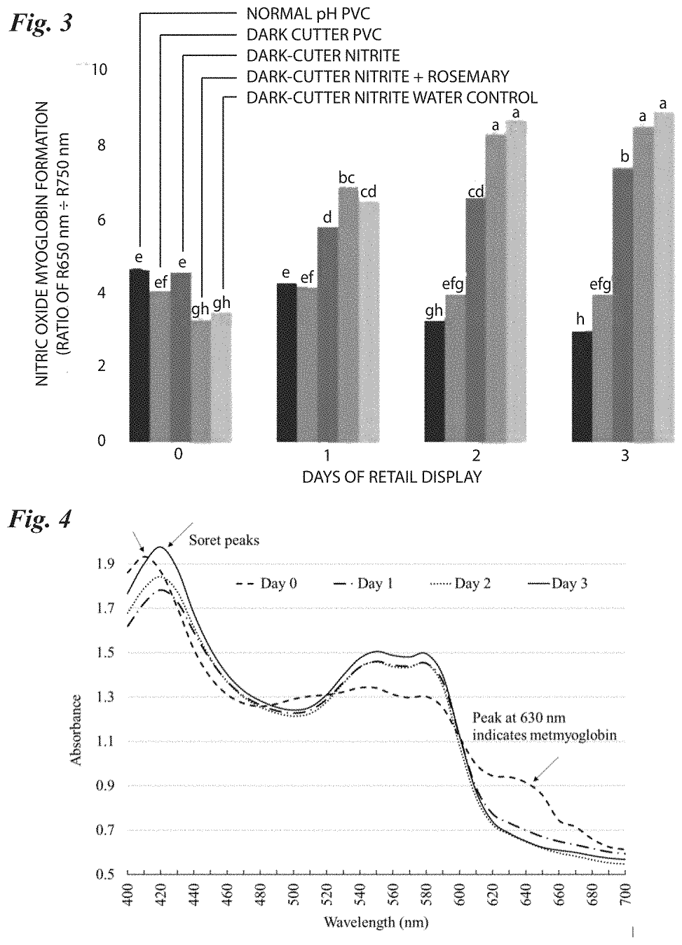

There was a significant treatment×storage time interaction for a* values, chroma, ratio of R650÷R570 nm, and metmyoglobin content (FIGS. 1, 2, 3, and Table 2).

TABLE 2
Effects of nitrite-embedded packaging¹ and
retail display on metmyoglobin formation²

| | Days of retail display | | | |
|---|---|---|---|---|
| Treatments | 0 | 1 | 2 | 3 |
| Normal-pH PVC | 1.391 ^{a,w} | 1.325 ^{b,wxy} | 1.230 ^{c,y} | 1.134 ^{d,y} |
| Dark-cutter PVC | 1.251 ^{a,x} | 1.209 ^{ab,y} | 1.192 ^{bc,y} | 1.152 ^{c,y} |
| Dark-cutter | 0.967 ^{c,z} | 1.334 ^{b,wx} | 1.357 ^{ab,x} | 1.393 ^{a,x} |
| nitrite | | | | |
| Dark-cutter | 1.019 ^{c,y} | 1.368 ^{b,w} | 1.423 ^{a,w} | 1.440 ^{a,w} |
| nitrite + rosemary | | | | |
| Dark-cutter | 1.037 ^{c,y} | 1.309 ^{b,xy} | 1.415 ^{a,w} | 1.437 ^{a,wx} |
| nitrite water control | | | | |

¹Treatments included normal-pH steak packaged in PVC, dark-cutting steak packaged in PVC, dark-cutting packaged in nitrite-embedded, dark-cutting steak dipped in 0.2% rosemary solution and packaged in nitrite-embedded film, and dark-cutting steak dipped in distilled water and packaged in nitrite-embedded film.
²Metmyoglobin formation was calculated as K/S572 ÷ K/S525 nm. A lower number indicates greater metmyoglobin formation.
Least square means within a row with different letters (a-d) differ (P < 0.05).
Least square means within a column with different letters (w-z) differ (P < 0.05).
Standard error = 0.025

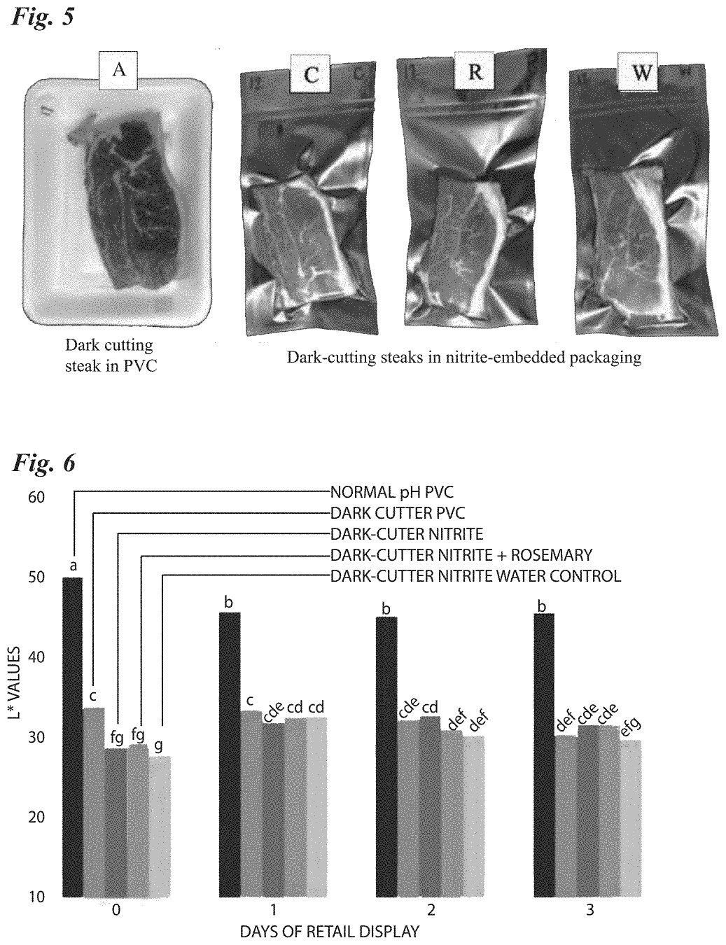

Dark-cutting treatments had lower redness (P<0.05; a* values) than normal-pH steaks on day 0 of display. Within the dark-cutting treatments, on day 0 of display, nitrite-embedded packaging treatments had lower redness (P<0.05) than dark-cutting steaks in PVC. Nitrite is a potent oxidizing agent, hence myoglobin can be oxidized to form nitric oxide metmyoglobin. The absorbance spectra (peak at 630 nm; FIG. 4) and a lower ratio of K/S 572÷K/S 525 (Table 2) indicated greater metmyoglobin on day 0 in nitrite-embedded packaging compared with dark-cutting beef in PVC. Research using normal-pH ground beef and the nitrite-embedded film also reported that the formation of red color is not immediate and it took five days to have redder color (Yang et al., 2006). Meat has an inherent reducing capacity to reduce metmyoglobin to deoxymyoglobin, and a greater pH can accelerate this conversion (Zhu and Brewer, 1998; Djimsa et al., 2017). Dark-cutting beef has greater metmyoglobin reducing activity than normal-pH beef (English et al., 2016b; McKeith et al., 2016); hence, the formation of bright-red nitric oxide myoglobin was faster. From day 1 onwards, nitrite-embedded treatments had greater a* values and chroma than dark-cutting steaks in PVC (FIG. 5). On day 3 of display, nitrite-embedded treatment with rosemary had greater numerical a* values compared with other dark-cutting treatments. The ratio of R650÷R570 nm for nitrite-embedded treatments increased with storage time, indicating more nitric oxide myoglobin formation. In support, absorbance spectrum also indicated more nitric oxide myoglobin with storage time (FIG. 6; increase in absorbance at 550 and 570 nm). On days 2 and 3, both rosemary and distilled water treatments had greater nitric oxide formation than control dark-cutting steak in nitrite-embedded packaging.

In one embodiment, both rosemary and distilled water treatments in nitrite-embedded film had greater redness than control nitrite-embedded film treatment. Although the mechanism of improved color stability is not clear, it is possible that the antioxidant effect of rosemary may have limited nitric oxide myoglobin oxidation. More specifically, nitric oxide myoglobin is sensitive to light-induced photo-oxidation, hence the addition of rosemary may have increased redox stability. Previous research indicated that light exposed steaks packaged in nitrite-embedded film had lower redness than dark-storage steaks packaged in nitrite-embedded film (Claus and Du, 2013). The antioxidant effects of rosemary in beef were noted by previous studies (Sánchez-Escalante et al., 2003; Wills et al., 2017). Further, dark-cutting beef has lower moisture content than normal pH beef. Hence, water in rosemary and distilled water treatment may have increased diffusion of nitrite from the packaging material to meat surface.

Redness of normal-pH steaks decreased (P<0.05) with storage time, while no changes in a* values (P>0.05) were observed for dark-cutting steak packaged in PVC during 3-day display. There were no differences (P>0.05) in ratio of R650÷R570 nm for dark-cutting steaks packaged in PVC. However, ratio of R650÷R570 nm decreased for normal-pH steak packaged in PVC between days 1 and 2, which can be attributed to metmyoglobin formation.

### Surface Lightness (L* Values)

There was a significant treatment×storage time interaction for L* values (P<0.05; FIG. 6). Normal-pH steaks packaged in PVC were lighter (P<0.05) in color than dark-cutting treatments. Many studies have shown that dark-cutting steaks have lower L* values than normal-pH steaks (Apple et al., 2011; English et al., 2006b). On day 0 of display, dark-cutting steaks packaged in PVC had greater L* values than dark-cutting steaks in nitrite-embedded packaging. Although redness was improved on days 1, 2, and 3, there were no differences (P>0.05) in L* values between dark-cutting treatments observed. Water treatment was included to determine the effects of water on reflectance properties. Water-enhancement increased lightness or L* values of ground beef (Seyfert et al., 2007), normal-pH longissimus steaks (Ramanathan et al., 2010), and dark-cutting steaks (Wills et al., 2017); conversely minimal effect on lightness (L* values) was observed.

### Total Plate Count

Dark-cutting steaks in nitrite-embedded packages had lower (P<0.05) total plate counts than dark-cutting steaks packaged in PVC on day 3 of display (average total plate count per cm² for dark-cutting steaks in nitrite-embedded packaging=5.61 and dark-cutting steaks in PVC=6.72; standard error=0.24). A greater pH favors the growth of spoilage bacteria (Gill and Newton, 1979). One log decrease in total plate count can be attributed to lower oxygen content within the package. For example, nitrite-embedded packaging creates a low or anaerobic condition, while PVC is an aerobic packaging. In support, previous research also reported nitrite-embedded packaging had an approximate 1.5-log reduction in psychrophilic bacteria than PVC (Narváez-Bravo et al., 2017).

According to another embodiment, as an alternative to rosemary, other antioxidants could be used instead of, or with rosemary, including, without limitation Ascorbic Acid and Tocopherols. Additional agents might be added into the meat treatment process including, glucono-delta-lactone in combination with rosemary. In one embodiment a solution was injected into dark-cutting beef to lower its pH and improve its color. Dark-cutting beef was later packaged in nitrite-embedded film.

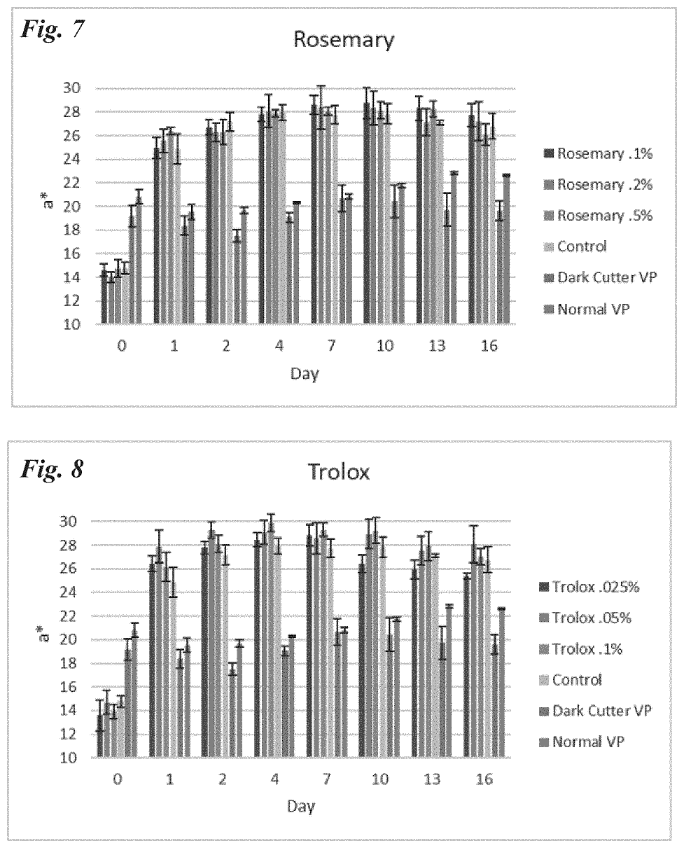

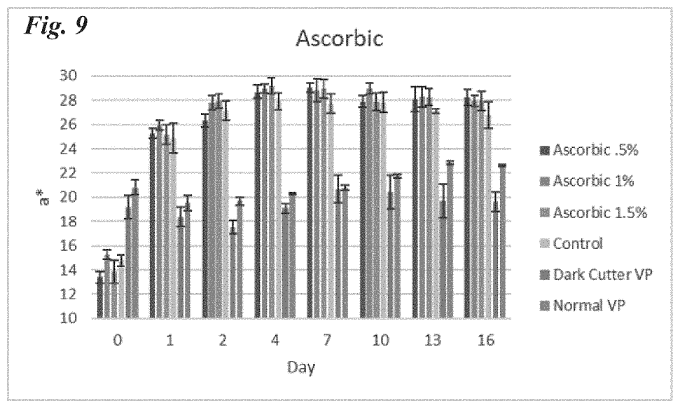

According to another embodiment and as is illustrated in FIGS. 7, 8, and 9, eight dark-cutting beef carcasses (pH>6.0) and eight USDA Low Choice (normal-pH; mean pH=5.6) beef strip loins (longissimus lumborum) were selected from the Tyson Fresh Beef Plant at Amarillo, Tex., 3 days after harvest. Carcasses were fabricated, strip loins were collected, vacuum packaged, and transported on ice to the Robert M. Kerr Food & Agricultural Products Center at the Oklahoma State University campus in Stillwater. Each dark-cutting loin was sliced into five 2.5-cm thick steaks from the anterior end using a meat slicer and randomly assigned to three antioxidants:
1. Rosemary, FIG. 7,
2. Trolox (water soluble analog of vitamin E, i.e., 3,4-dihydro-6-hydroxy-2,5,7,8-tetramethyl-2H-1-benzopyran-2-carboxylic acid), FIG. 8,
3. Ascorbic acid (vitamin C), FIG. 9.

In FIGS. 7-9 the various treatments listed vertically in the chart legend can be found in the chart depicted from left-to-right for each day. For example, in Fig. 0.1% Rosemary is the left-most bar each day, 0.2% Rosemary is the bar that is second from the left, etc. This same pattern is repeated for each day. FIGS. 8 and 9 should be interpreted the same way.

Trolox was applied at levels of 0.025, 0.05, and 0.1%, rosemary was applied at levels of 0.1, 0.2, and 0.5%, and ascorbic acid was applied at levels of 0.5, 1, and 1.5%. In addition, three controls were created, a dark-cutting loin in nitrite packaging, a dark-cutter in vacuum packaging (without nitrite), and a normal-pH vacuum packaging.

In each case, the steaks assigned to the different treatments were dipped, respectively, in rosemary, Trolox, and ascorbic acid solution and packaged in nitrite-embedded packaging. Surface color was measured using a HunterLab spectrophotometer. The experiment was repeated four times.

As in indicated in the embodiment of FIGS. 7-9, packaging nitrite-embedded film increased redness of dark-cutting by 45%. A combination of rosemary enhancement and modified atmospheric packaging improved surface redness of dark-cutting beef by 44.5% (Wills et al., 2017). Improved redness in rosemary-enhancement was due to increased reflectance by water, modified gas composition within the package, and antioxidant effect. Additionally, Ascorbate at all levels improved redness compared with control nitrite. Trolox was most effective followed by ascorbate and rosemary.

### Conclusion

Surface redness and chroma were greater for steaks packaged in nitrite-embedded film than dark-cutting steaks in PVC. A greater muscle pH accelerated the formation of bright-red nitric oxide myoglobin. Improved redness in nitrite-embedded treatment was not supported by an increase in L* values. Rosemary-dipped steaks packaged in nitrite-embedded film was the most effective in improving surface of dark-cutting steaks. Therefore, understanding fundamental myoglobin chemistry has the potential to develop effective post-harvest strategies that can improve surface color and value of dark-cutting beef.

Finally, one aspect of the approach utilized herein is that the prior art has not appreciated is the synergistic effect obtained when both Rosemary and nitrite-embedded film are used to treat dark cutting beef. Such is a key finding of the disclosure herein.

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

### REFERENCES

American Meat Science Association. 2012. Meat Color Measurement Guidelines. Am. Meat Sci. Assoc., Chicago, Ill.
Apple, J. K., J. T. Sawyer, J.-F. Meullenet, J. W. S. Yancey, and M. D. Wharton. 2011. Lactic acid enhancement can improve the fresh and cooked color of dark-cutting beef. J. Anim. Sci. 89:4207-4220.
Ashmore, C. R., W. Parker, and L. Doerr. 1972. Respiration of mitochondria isolated from dark-cutting beef: postmortem changes. J. Anim. Sci. 34:46-48.
Barbut, S., L. Zhang, and M. Marcone. 2005. Effects of pale, normal, and dark chicken breast meat on microstructure, extractable proteins, and cooking of marinated fillets. Poultry Sci. 84:797-802.
Boykin, C. A., L. C. Eastwood, M. K. Harris, D. S. Hale, C. R. Kerth, D. B. Griffin, A. N. Arnold, J. D. Hasty, K. E. Belk, D. R. Woerner, R. J. Delmore, J. N. Martin, D. L. VanOverbeke, G. G. Mafi, M. M. Pfeiffer, T. E. Lawrence, T. J. McEvers, T. B. Schmidt, R. J. Maddock, D. D. Johnson, C. C. Carr, J. M. Scheffler, T. D. Pringle, A. M. Stelzleni, J. Gottlieb, and J. W. Savell. 2017. National Beef Quality Audit-2016: In-plant survey of carcass characteristics related to quality, quantity, and value of fed steers and heifersl. J. Anim. Sci. 95:2993-3002.
Claus, J. R., and C. Du. 2013. Nitrite-embedded packaging film effects on fresh and frozen beef color development and stability as influenced by meat age and muscle type. Meat Sci. 95: 526-535.
Cornforth, D., and M. Hunt. 2008. Low-oxygen packaging of fresh meat with carbon monoxide. Meat quality, microbiology, and safety. AMSA White Paper Series, (number 2) (pp. 1-10). Savoy, Ill.: American Meat Science Association.
Djimsa, B. A., A. Abraham., G. Mafi., D. VanOverbeke., and R. Ramanathan. 2017. Effects of metmyoglobin reducing activity and thermal stability of NADH-dependent reductase and lactate dehydrogenase on premature browning in ground beef. J. Food Sci. 82: 304-313.
English, A. R., G. G. Mafi, D. L. VanOverbeke, and R. Ramanathan. 2016a. Effects of extended aging and modified atmospheric packaging on beef top loin steak color. J. Animal Sci. 94:1727-1737.
English, A. R., K. M. Wills, B. N. Harsh, G. G. Mafi, D. L. VanOverbeke, and R. Ramanathan. 2016b. Effects of aging on the fundamental color chemistry of dark-cutting beef J. Anim Sci. 94:4040-4048.
Faustman, C., and A. L Phillips. 2001. Measurement of discoloration in fresh meat. Current protocols in food analytical chemistry. New York: Wiley (Ch. F3 Unit F3.3). p. 139-151.
Fox, Jr. J. B. and S. A. Ackerman. 1968. Formation of nitric oxide myoglobin: mechanisms of the reaction with various reductants. J. Food Sci. 33: 364-370.
Gill, C. O. and K. G. Newton. 1979. Spoilage of vacuum-packaged dark, firm, dry meat at chill temperatures. Appl. Environ. Microbiol. 37:362-364.
Hendrick, H. B., J. B. Boillot, D. E. Brady, and H. D. Naumann. 1959. Etiology of dark-cutting beef. Res. Bull. 717. University MO Agric. Exp. Stn., Columbia.
Mitacek, R. M., A. R. English, G. G. Mafi, D. L. VanOverbeke, R. Ramanathan. (2018). Modified atmospheric packaging improves the surface color of dark-cutting beef Meat and Muscle Bio. Accepted, In-press. doi:10.22175/mmb2017.04.0023
Hughes, J., F. Clarke., P. Purslow., and R. Warner. 2017. High pH in beef longissimus thoracis reduces muscle fibre transverse shrinkage and light scattering which contributes to the dark colour. Food Rese. Inter. 101: 228-238.
Hunt, M. C., and H. B. Hedrick. 1977. Profile of fiber types and related properties of 5 bovine muscles. J. Food Sci. 42:513-517.
Mahmood, S., B. C. Roy., I. L. Larsen., J. L. Aalhus., W. T. Dixon., and H. L. Bruce. 2017. Understanding the quality of typical and atypical dark cutting beef from heifers and steers. Meat Sci. 133:75-85.
Mahmood, S., N. Turchinsky., F. Paradis., W. T. Dixon., and H. L. Bruce. 2017. Proteomics of dark cutting longissimus thoracis muscle from heifer and steer carcasses. Meat Sci. In Press.
McKeith, R. O., D. A. King, A. L. Grayson, S. D. Shackelford, K. B. Gehring, J. W. Savell, and T. L. Wheeler. 2016. Mitochondrial abundance and efficiency contribute to lean color of dark cutting beef. Meat Sci. 116:165-173.
Mitsumoto, M., R. G. Cassens., D. M. Schaefer., R. N. Arnold., and K. K. Scheller. 1991. Improvement of color and lipid stability in beef longissimus with dietary vitamin E and vitamin C dip treatment. J. Food Sci. 56:1489-1492.
Narváez-Bravo, C., A. Rodas-González, C. Ding, O. López-Campos, J. Galbraith, I. L. Larsen, J. Ye, D. Siegel, and J. L. Aalhus. 2017. Effects of novel nitrite packaging film on the bacterial growth of bison strip-loin steaks. J. Food Proc. Preserv. 41:e13311.
Ramanathan, R., R. A. Mancini, B. M. Naveena, M. K. R. Konda. 2010. Effect of lactate-enhancement on reflectance and absorbance of beef longissimus steaks. Meat Sci. 84:219-226.
Roberts, J. C., A. Rodas-Gonzalez., J. Galbraith., M. E. R. Dugan., I. L. Larsen., J. L. Aalhus., and Ó. López-Campos. 2017. Nitrite embedded vacuum packaging improves retail color and oxidative stability of bison steaks and patties. Meat Mus. Bio. 1:169-180.
Sánchez-Escalante, A., D. Dkenane, G. Torrescano, J.A. Beltrán, and P. Roncales. 2003. Antioxidant action of borage, rosemary, oregano, and ascorbic acid in beef patties packaged in modified atmosphere. J. Food Sci. 68:339-344.
Sawyer, J. T., J. K. Apple, Z. B. Johnson, R. T. Baublits, and J. W. S. Yancey. 2009. Fresh and cooked color of dark-cutting beef can be altered by enhancement with lactic acid. Meat Sci. 83:263-270.
Seyfert, M., M. C. Hunt, M Ahnstrom, and D. E. Johnson. 2007. Efficacy of lactic acid salts and sodium acetate on ground beef colour stability and metmyoglobin reducing activity. Meat Sci. 75:134-142.
Siegel, D. G. 2011. An update on packaging fresh meat with nitrite containing film. 64th Reciprocal Meat Conference. Kansas State University.
Yang, X., D. R. Woerner, J. D. Hasty, K. R. McCullough, I. Geornaras, J. N. Sofos, and K. E. Belk. 2016. An evaluation of the effectiveness of Freshcase technology to extend the storage life of whole muscle beef and ground beef. J. Anim. Sci. 94:4911-4920.
M. Wills, R. M. Mitacek, G. G. Mafi, D. L. VanOverbeke, D. Jaroni, R. Jadeja, and R. Ramanathan. (2017). Improving the lean muscle color of dark-cutting beef by aging, antioxidant-enhancement, and modified atmospheric packaging. Journal of Animal Science. 95:5378-5387.
Zhu, L. G., and Brewer, M. S. (1998). Metmyoglobin reducing capacity of fresh normal, PSE and DFD pork during retail display. J. Food Sci. 63:390-393.

What is claimed is:

1. A method of treating post-harvested dark cutting beef comprising:
(a) treating the beef with an antioxidant; and
(b) storing the antioxidant treated beef in a nitrite-embedded package for a predetermined period of time.

2. The method according to claim 1, wherein said period of time is less than or equal to three days.

3. The method according to claim 1, wherein step (a) comprises the step of treating the beef with an antioxidant comprising a Rosemary solution having a concentration of between 0.1% and 0.2% Rosemary.

4. The method according to claim 1, wherein step (a) comprises the step of treating the beef with an antioxidant comprising a Trolox solution having a concentration of between 0.5% and 1.5% Trolox.

5. The method according to claim 1, wherein step (a) comprises the step of treating the beef with an antioxidant comprising an ascorbic acid solution having a concentration of between 0.025% and 0.1% ascorbic acid.

6. The method according to claim 1, wherein step (a) comprises the step of treating the beef with a solution comprised of at least one of Rosemary, Trolox, and ascorbic acid.

7. The method according to claim 1, wherein said antioxidant comprises either Rosemary, Trolox, or ascorbic acid

8. A post-harvested dark cutting beef product prepared by the method of
(a) treating the beef with an antioxidant solution; and
(b) storing the antioxidant-treated beef in a nitrite-embedded package for a predetermined period of time.

9. The method according to claim 8, wherein said period of time is less than or equal to three days.

10. The method according to claim 8, wherein step (a) comprises the step of treating the beef with an antioxidant solution comprised of at least one of Rosemary, Trolox, and ascorbic acid.

11. The method according to claim 8, wherein said antioxidant comprises either Rosemary, Trolox, or ascorbic acid.

12. The method according to claim 8, wherein step (a) comprises the step of treating the beef with an antioxidant comprising a Rosemary solution having a concentration of between 0.1% and 0.2% Rosemary.

13. The method according to claim 8, wherein step (a) comprises the step of treating the beef with an antioxidant comprising a Trolox solution having a concentration of between 0.5 and 1.5% Trolox.

14. The method according to claim 8, wherein step (a) comprises the step of treating the beef with an antioxidant comprising an ascorbic acid solution having a concentration of between 0.025% and 0.1% ascorbic acid.
